(19) United States
(12) Patent Application Publication
(10) Pub. No.: US 2024/0322487 A1
(43) Pub. Date: Sep. 26, 2024

(54) CONNECTOR

(71) Applicant: SUMITOMO WIRING SYSTEMS, LTD., Mie (JP)

(72) Inventor: Ren MIYAZAKI, Mie (JP)

(21) Appl. No.: 18/610,576

(22) Filed: Mar. 20, 2024

(30) Foreign Application Priority Data
Mar. 24, 2023 (JP) 2023-048068

(51) Int. Cl. H01R 13/629

(52) U.S. Cl. CPC H01R 13/62933

(57) ABSTRACT

A lock arm holds a connector and a counterpart connector in a fitted state. The lock arm extends from a main body part in the manner of a cantilever. The lock arm comes into contact with the counterpart connector and elastically deforms downward in the course of fitting. The lock arm has, on a lower surface, a reference surface that is disposed so as to extend from a base end side toward a free end side and a concave surface that is located above the reference surface via a step part on the free end side in a state where the lock arm is not elastically deformed. The main body part has an interference part that comes into contact with an end portion on the free end side including the concave surface displaced downward.

### CROSS-REFERENCE TO RELATED APPLICATIONS

This application is based on and claims priority from Japanese Patent Application No. 2023-048068, filed on Mar. 24, 2023, with the Japan Patent Office, the disclosure of which is incorporated herein in its entirety by reference.

### TECHNICAL FIELD

The present disclosure relates to a connector.

### BACKGROUND

The connector disclosed in JP 2006-040691 A includes a female housing and a male housing that can be fitted to each other. The female housing has a lock arm that locks a lock receiving part of a male housing of a counterpart connector and holds the connector and the counterpart connector in a fitted state. The lock arm interferes with the male housing and is pressed downward in the course of fitting between the female housing and the male housing. At this time, the lock arm elastically deforms in a bending space formed above the main body of the female housing without coming into contact with the main body. JP 2006-318844 A and JP 2009-283343 A also disclose a connector including a lock arm.

### SUMMARY

With the aim of reducing the profile of the male housing of the counterpart connector, lowering the height-wise position of the lock arm where contact is made with the male housing in the course of fitting may be required, for example. However, if the lock arm is configured to elastically deform in the bending space formed above the main body of the female housing, there is a problem that the height-wise position of the lock arm cannot be sufficiently lowered.

In view of this, the present disclosure provides a connector that can sufficiently lower the height-wise position of a lock arm where contact is made with a counterpart connector in the course of fitting.

A connector of the present disclosure includes: a lock arm that holds the connector; and a counterpart connector in a fitted state and a main body part to which the lock arm is coupled, wherein the lock arm extends from the main body part in the manner of a cantilever, when the lock arm comes into contact with the counterpart connector and elastically deforms downward in a course of fitting between the connector and the counterpart connector, the lock arm has, on a lower surface, a reference surface that is disposed so as to extend from a base end side toward a free end side and a concave surface that is located above the reference surface via a step part on the free end side in a state where the lock arm is not elastically deformed, the main body part has an interference part that comes into contact with an end portion on the free end side including the concave surface displaced downward, and a portion of the reference surface is set so as to be positioned below a position of contact between the end portion on the free end side and the interference part when the end portion on the free end side comes into contact with the interference part.

According to the present disclosure, provided is a connector that can sufficiently lower the height-wise position of a lock arm where contact is made with a counterpart connector in the course of fitting.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side cross-sectional view showing a state in which a connector is fitted to a counterpart connector in a first embodiment.

FIG. 2 is a plan view showing a state in which the connector is fitted to the counterpart connector in the first embodiment.

FIG. 3 is a perspective view of a lever in the first embodiment.

FIG. 4 is an enlarged side cross-sectional view of a part of the lever including a lock arm and an interference part in the first embodiment.

FIG. 5 is an enlarged rear view of a part of the lever including the lock arm in the first embodiment.

FIG. 6 is an enlarged side cross-sectional view showing a state in which a free end side of the lock arm is displaced maximally downward and a concave surface interferes with the interference part in the first embodiment.

FIG. 7 is an enlarged side cross-sectional view showing a state in which a lock projection of the lock arm is locked to a lock receiving part in the first embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure will be listed and described.

(1) A connector of the present disclosure includes: a lock arm that holds the connector and a counterpart connector in a fitted state; and a main body part to which the lock arm is coupled, wherein the lock arm extends from the main body part in the manner of a cantilever, when the lock arm comes into contact with the counterpart connector and elastically deforms downward in a course of fitting between the connector and the counterpart connector, the lock arm has, on a lower surface, a reference surface that is disposed so as to extend from a base end side toward a free end side and a concave surface that is located above the reference surface via a step part on the free end side in a state where the lock arm is not elastically deformed, the main body part has an interference part that comes into contact with an end portion on the free end side including the concave surface displaced downward, and a portion of the reference surface is set so as to be positioned below a position of contact between the end portion on the free end side and the interference part when the end portion on the free end side comes into contact with the interference part.

In the above-described configuration, a portion of the reference surface can be positioned below the position of contact between the end portion on the free end side and the interference part, and thus it is possible to lower the height-wise position of the lock arm where contact is made with the counterpart connector in the course of fitting. As a result, it is possible to achieve a lower profile of the counterpart connector.

(2) It is preferable that the connector according to (1) further includes a lever that advances the fitting between the connector and the counterpart connector, wherein the main body part constitutes a main portion of a plate-like cam part of the lever, and the lock arm is constituted by a portion of the cam part excluding the main portion, the cam part has an open space extending in a plate thickness direction, and a portion of the reference surface enters the open space when the end portion on the free end side comes into contact with the interference part.

The above-described configuration makes it possible to further lower the height-wise position of the lock arm where contact is made with the counterpart connector. The above-described configuration also makes it possible to effectively use the open space that could be a dead space.

(3) In the connector according to (1) or (2), the lock arm preferably has a protruding part on the free end side of an upper surface.

The above-described configuration can prevent the free end side of the lock arm from being partially thin due to the formation of the step part and the concave surface, and improve the fluidity and moldability of a resin used to mold the lock arm.

(4) In the connector according to (3), the lock arm preferably has an arm part that extends from the base end side toward the free end side, a press part that is disposed at the end portion on the free end side and above the arm part, and a coupling part that couples the arm part and the press part, and the protruding part and the concave surface are preferably provided on the coupling part.

The above-described configuration makes it possible to distribute the stress acting on the coupling part when the press part is pressed, to the step part and also the protruding part, thereby avoiding the concentration of stress on the step part. Therefore, the above-described configuration makes it easy to ensure rigidity of the coupling part.

### DETAILS OF EMBODIMENTS OF PRESENT DISCLOSURE

Specific examples of the present disclosure will be described below with reference to the drawings. It should be noted that the present invention is not limited to the examples herein, but rather is indicated by the scope of the claims, and is intended to include all modifications within a meaning and scope equivalent to the scope of claims.

### First Embodiment

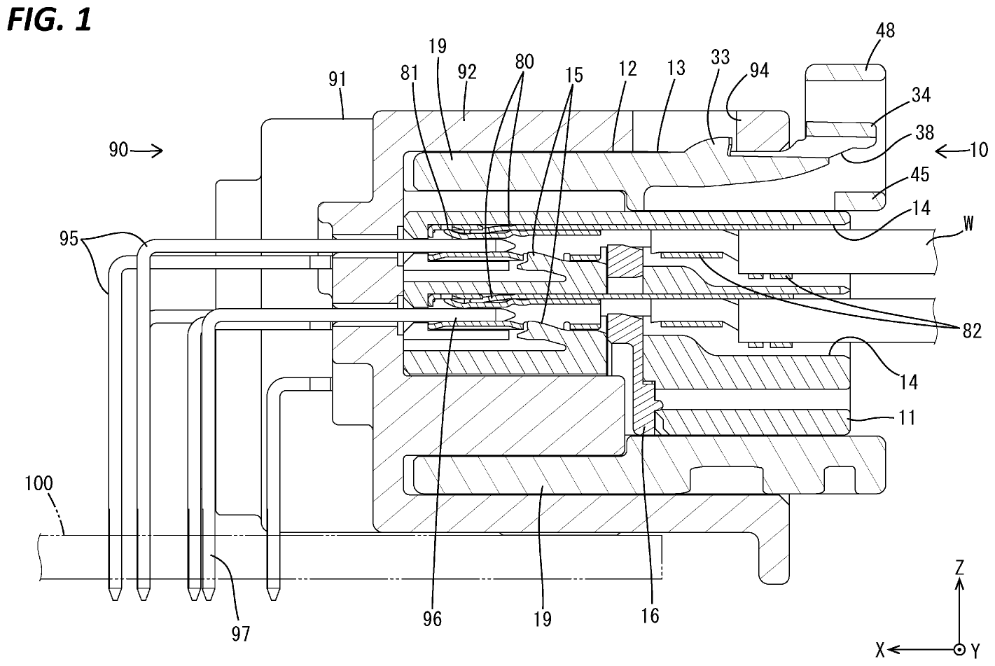

As shown in FIG. 1, a connector 10 according to a first embodiment includes a housing 11 that can be fitted to a counterpart connector 90, terminal fittings 80 that are housed in the housing 11, and a lever 12 that is disposed so as to be pivotable with respect to the housing 11. The lever 12 has an elastically deformable lock arm 13 that locks the counterpart connector 90. In the following description, in the front-back direction, the side on which the connector 10 and the counterpart connector 90 face each other at the start of fitting is the forward side. As viewed from the connector 10, the arrow X in FIG. 1 indicates the forward side. In FIG. 1, reference sign Y indicates the right side, and the arrow Z indicates the upward side. Herein, the vertical direction and the horizontal direction are synonymous with the height direction and the width direction, respectively. The references for these directions do not necessarily coincide with the references for the directions in the state where the connector 10 is mounted in a vehicle or the like (not shown). Accordingly, herein, the downward side is not limited to the downward side in the direction of a gravitational force.

### (Counterpart Connector 90)

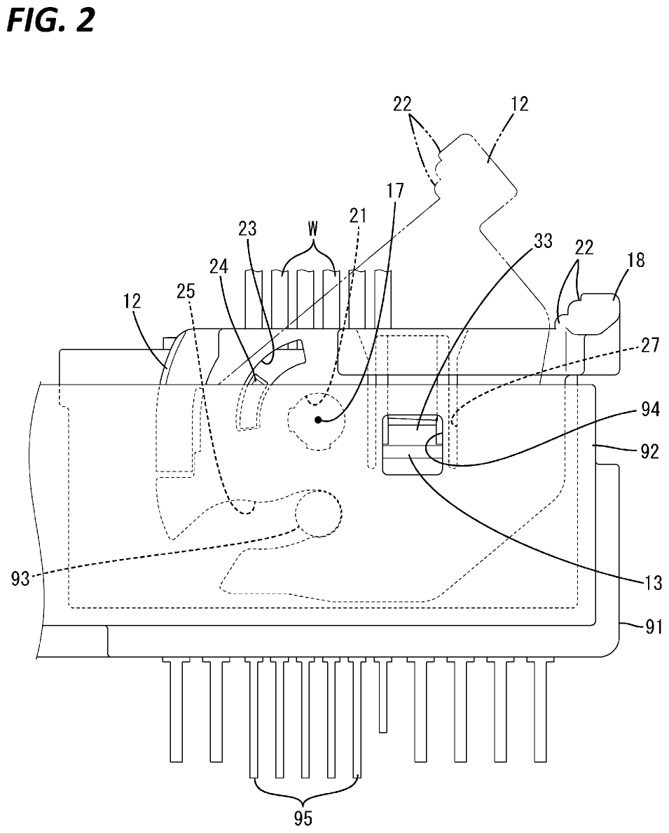

As shown in FIG. 1, the counterpart connector 90 includes a counterpart housing 91 and a plurality of counterpart terminal fittings 95 that are attached to the counterpart housing 91. The counterpart connector 90 is configured to be a board connector formed on a circuit board 100. The counterpart housing 91 is made of a synthetic resin and has a square tube-shaped hood part 92 that is open forward. The hood part 92 has a round columnar cam pin 93 (see FIG. 2) that protrudes from a central part in the horizontal direction between the inner surfaces of the upper wall and the lower wall. As shown in FIG. 2, the hood part 92 has a lock receiving part 94 on one side (the right side in FIG. 2) in the horizontal direction of the upper wall. As shown in FIG. 1, the lock receiving part 94 extends through the upper wall of the hood part 92 in the vertical direction (thickness direction).

Each counterpart terminal fitting 95 has a pin-like shape extending in an elongated manner. The counterpart terminal fitting 95 has a terminal connection part 96 that extends in the front-back direction and penetrates the back wall of the hood part 92, and a board connection part 97 that extends downward from the back end of the terminal connection part 96. The terminal connection part 96 has a portion that protrudes inward of the hood part 92 and is electrically connected to the corresponding terminal fitting 80 when the connector 10 and the counterpart connector 90 are fitted to each other. The board connection part 97 has a lower end portion that is soldered and electrically connected to a conductive part of the circuit board 100.

### (Housing 11, Terminal Fittings 80, and Others)

The housing 11 is made of a synthetic resin and, as shown in FIG. 1, has a plurality of cavities 14 at positions corresponding to the counterpart terminal fittings 95, and has lances 15 that protrude from the inner wall of each cavity 14. The terminal fittings 80 are inserted into the cavities 14 from the back side and locked by the lances 15, and thus primarily retained in the housing 11. Each terminal fitting 80 is made of an electrically conductive metal and has a square tube-shaped connection part 81 and a barrel part 82 that is electrically and mechanically connected to the terminal end part of an electric wire W on the back side of the connection part 81. The counterpart terminal fittings 95 are inserted into and electrically connected to the connection parts 81. The housing 11 has a retainer 16 attached thereto to secondarily restrict dislodgement of the terminal fittings 80. The housing 11 has two shaft parts 17 (see FIG. 2) that respectively protrude from the upper surface and the lower surface.

### (Lever 12)

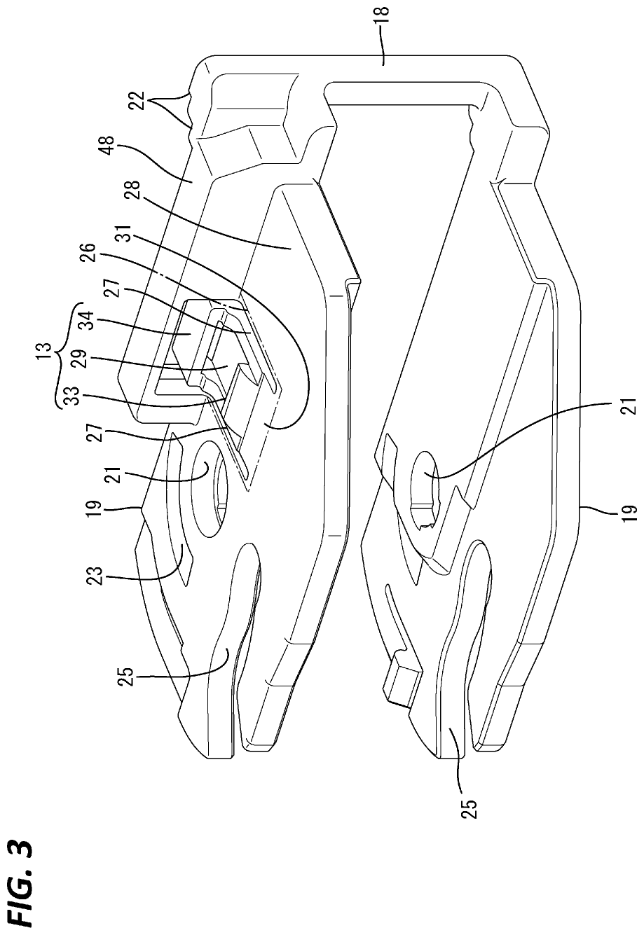

The lever 12 is made of a synthetic resin and, as shown in FIG. 3, has an operation part 18 that extends in the vertical direction and two cam parts 19 that protrude parallel to each other from the end portions of the operation part 18 in the vertical direction. Each cam part 19 has a plate-like shape and has a shaft hole 21 that receives the corresponding shaft part 17. As shown in FIG. 2, the lever 12 is pivotably supported by the housing 11 at an initial position and a fitting position about the shaft parts 17 fitted into the shaft holes 21. In the following description, the front-back direction of the lever 12 is set with reference to the front-back direction in which the lever 12 is at the fitting position fitted to the housing 11.

The operation part 18 is a part that is to be held by a worker when pivoting the lever 12, and has a step-like anti-slip part 22. At the initial position, the anti-slip part 22 is separated backward from the back surface of the housing 11 (see the two-dot dash line in FIG. 2), and at the fitting position, the anti-slip part 22 is close to the back surface of the housing 11 (see the solid line in FIG. 2).

Each cam part 19 has a guide groove 23 that is curved in an arc at a position concentric to the shaft hole 21. An arc-shaped guide rib 24 provided on the housing 11 is inserted into the guide groove 23. The pivoting operation of the lever 12 is guided along the guide rib 24 inserted into the guide groove 23.

Each cam part 19 has a cam groove 25 that extends curved from the vicinity of the shaft hole 21 to the outer peripheral edge of the cam part 19, as shown in FIGS. 2 and 3. When the lever 12 is at the initial position, the entrance of the cam groove 25 is oriented forward. In a state where the cam pin 93 of the counterpart connector 90 has entered the entrance of the cam groove 25, the lever 12 is pivoted from the initial position toward the fitting position. In the course of pivoting the lever 12, the cam pin 93 slides along the groove surface of the cam groove 25, and the housing 11 is gradually deeply inserted into the hood part 92. This advances the fitting between the connector 10 and the counterpart connector 90. When the lever 12 reaches the fitting position, the cam pin 93 reaches the far end side of the cam groove 25, and the housing 11 is inserted into the hood part 92 at a proper (predetermined) depth.

Out of the cam parts 19, the upper cam part 19 is constituted by a lock structure part 26 including the lock arm 13 (the part indicated within the dotted line in FIG. 3) and a main body part 28 excluding the lock structure part 26. The lock structure part 26 is not provided on the lower cam part 19. In other words, the main body part 28 constitutes the main portion (large portion) of the cam part 19, and the lock arm 13 is constituted by a portion other than the main portion of the cam part 19.

As shown in FIG. 3, the lock structure part 26 is disposed on the side (the right side in FIG. 3) of the upper cam part 19 opposite to the side with the guide groove 23, the shaft hole 21, and the cam groove 25 with respect to the horizontal direction, and is disposed on the back side of the cam part 19 with respect to the front-back direction.

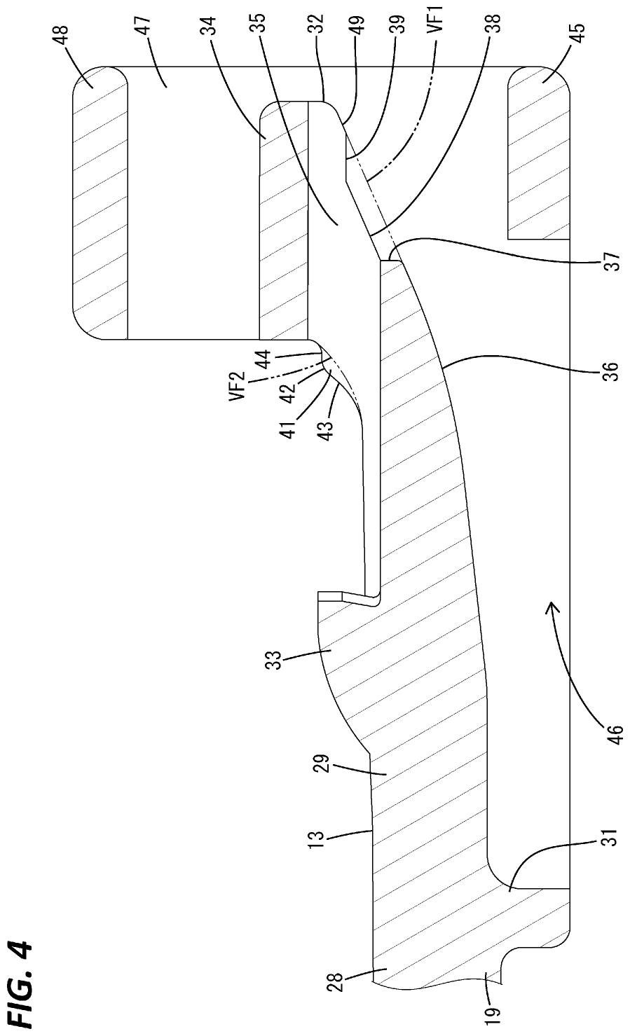

The lock structure part 26 has left and right slits 27. The lock arm 13 is disposed inward of the slits 27. The lock arm 13 extends in the manner of a cantilever with a certain width dimension on the back side of a portion between the front ends of the slits 27 in the main body part 28. The front end of the lock arm 13 is configured to be a base end 31 connected to the main body part 28. The back end of the lock arm 13 is configured to be a free end 32, as shown in FIG. 4.

The lock arm 13 is elastically deformable with the base end 31 serving as a fulcrum in a direction in which the free end 32 is displaced in the vertical direction. As shown in FIG. 4, the lock arm 13 has an arm part 29 that extends from the base end 31 toward the free end 32, a lock projection 33 that protrudes from the upper surface of the arm part 29, a press part 34 that is located higher by one step than the arm part 29 at the end portion on the free end 32 side, and coupling parts 35 that couple the arm part 29 and the press part 34 to each other.

The upper surface of the arm part 29 is continuous with the upper surface of the main body part 28 without a level change. The upper surface of the arm part 29 is disposed along the front-back direction in a state in which the lock arm 13 is not elastically deformed (hereinafter, called a natural state). In the following description, the height-wise position (vertical position) of the lock arm 13 is set with reference to the natural state of the lock arm 13 unless otherwise specified.

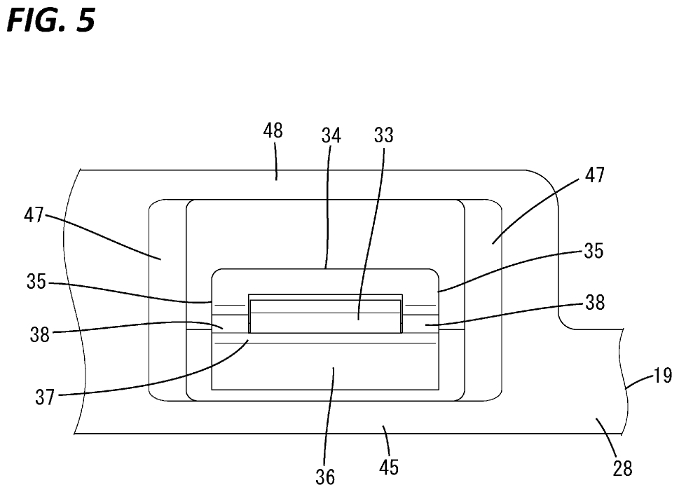

The lower surface of the arm part 29 is configured to be a reference surface 36 that serves as a reference for defining the position of a concave surface 38 described later and the like. The reference surface 36 of the arm part 29 is disposed so as to extend upward inclined from the base end 31 toward the free end 32. The back surface of the arm part 29 is disposed along the vertical direction, and is configured to be a step part 37 that forms a step between the arm part 29 and the concave surface 38. The reference surface 36 and the step part 37 are formed over the entire width in the horizontal direction of the arm part 29, as shown in FIG. 5.

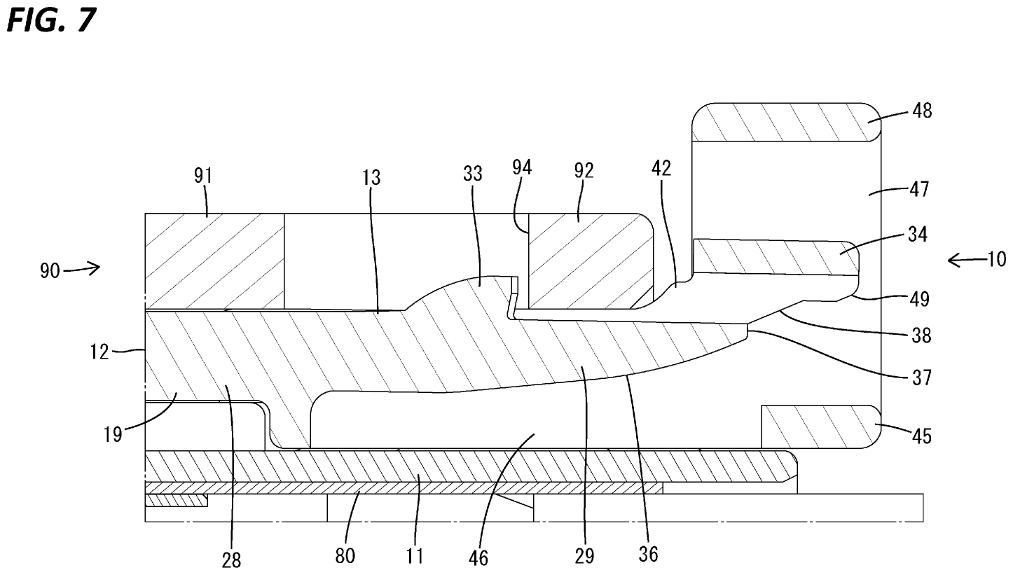

As shown in FIG. 4, the lock projection 33 has a claw-like shape and is disposed in the central portion of the arm part 29 in the front-back direction or on the front side (the base end 31 side) of the arm part 29. As shown in FIGS. 1 and 7, at the fitting position, the lock projection 33 is disposed so as to be able to be fitted and locked to the lock receiving part 94.

The press part 34 has a plate-like shape extending along the front-back direction. The upper surface of the press part 34 is located above the lock projection 33 and is flat along the horizontal direction and the front-back direction. By pressing the upper surface of the press part 34, the lock projection 33 can be released from the lock receiving part 94 and unlocked from the lock receiving part 94.

The coupling parts 35 are raised inclined upward while extending backward from the end portions on the left and right sides of the back end portion of the upper surface of the arm part 29, and each have an upper end that is connected to the press part 34. As shown in FIG. 5, the coupling parts 35 are disposed in a pair at the end portions on the right and left sides of the lock arm 13. The space located between the two coupling parts 35 and below the press part 34 is formed as a result of extraction from a metal mold (not shown) for molding the lock projection 33.

Each coupling part 35 has a plate-like shape and is disposed with plate surfaces thereof oriented in the horizontal direction and the plate-thickness surfaces thereof oriented in the vertical direction. As shown in FIG. 4, the lower surface (the lower plate-thickness surface) of the coupling part 35 is configured to be the concave surface 38 that can come into contact with an interference part 45 described later. The concave surface 38 is disposed inclined upward while extending backward from the upper end of the step part 37.

The end portion on the free end side of the arm part 29 is connected to the back end of the concave surface 38, and is constituted by a straight surface 39 that is horizontally disposed parallel to the lower surface of the back end portion of the press part 34, and an arm end portion 49 that extends curved from the straight surface 39 to the back end of the press part 34.

The concave surface 38 is located above a virtual surface VF1 that connects the back end of the reference surface 36 and the front end of the arm end portion 49. The portion of the lower surface of the lock arm 13 connected to the step part 37, the concave surface 38, and the straight surface 39 is formed so as to be concave with respect to the virtual surface VF1.

As shown in FIG. 4, the upper surface (the upper plate-thickness surface) of the coupling part 35 has a protruding part 41 at a position on the opposite side corresponding to the step part 37. The protruding part 41 has a peak part 42 on the protruding leading end side, a front ridge part 43 that is inclined upward from the upper surface of the arm part 29 to the peak part 42, and a back ridge part 44 that extends backward from the peak part 42 in the front-back direction and is connected with a step to the lower end portion of the front surface of the press part 34. The front ridge part 43 and the peak part 42 are located above a virtual surface VF2 that linearly connects the upper surface of the arm part 29 and the lower end portion of the front surface of the press part 34. The right and left surfaces (plate surfaces on the right and left sides) of each coupling part 35 are gradually increased in the width dimension in the front-back direction from the arm part 29 to the press part 34 by the protruding part 41.

As shown in FIG. 4, the main body part 28 (the portion of the upper cam part 19 excluding the lock arm 13) has the interference part 45 at a position below the concave surface 38, the straight surface 39, and the arm end portion 49 and facing the concave surface 38 and the like. The main body part 28 forms an open space 46 that extends through the main body part 28 in the vertical direction between the base end 31 of the lock arm 13 and the interference part 45. The interference part 45 has a plate-like shape that extends in the horizontal direction with a certain front-back width, and has upper and lower plate surfaces disposed along the front-back direction and the horizontal direction, as shown in FIG. 5.

As shown in FIG. 5, the upper cam part 19 has two leg parts 47 that protrude from the upper surface of the main body part 28 and cover the press part 34 and the coupling parts 35 from the right and left sides, and a cover part 48 that is connected to the upper ends of the leg parts 47 and covers the press part 34 from above. The back end portion (the end portion on the free end 32 side) of the lock arm 13 including the press part 34 is disposed between the cover part 48 and the interference part 45 with respect to the vertical direction. As shown in FIG. 3, the cover part 48 extends in the horizontal direction and has one end portion in the horizontal direction that is coupled to the anti-slip part 22 of the operation part 18. As shown in FIG. 5, the interference part 45 extends between the lower end sides of the leg parts 47 of the main body part 28.

### (Operation of Connector 10)

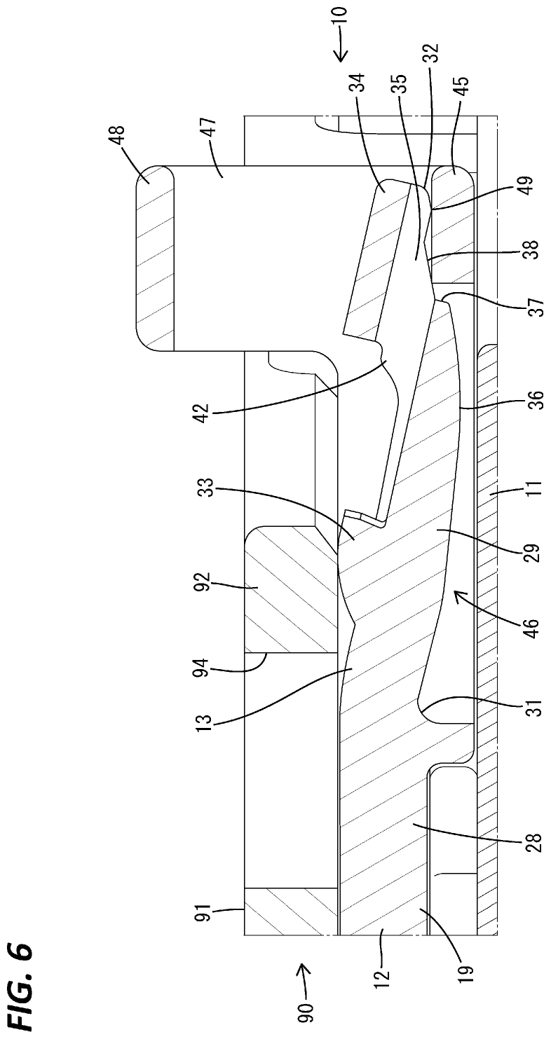

As described above, when the lever 12 is pivoted from the initial position to the fitting position and the cam pin 93 of the counterpart housing 91 slides along the groove surface of the cam groove 25 of the lever 12, fitting between the connector 10 and the counterpart connector 90 is advanced. In the course of fitting, as shown in FIG. 6, the housing 11 and the lever 12 are inserted into the hood part 92, the lock projection 33 interferes with the upper wall of the hood part 92, and the lock arm 13 is elastically deformed downward with the base end 31 serving as a fulcrum. The lock projection 33 slides along the inner surface of the upper wall of the hood part 92, and the free end 32 side is displaced downward. When the free end 32 side is displaced maximally downward, the arm end portion 49 that is the end portion on the free end 32 side and the concave surface 38 come into contact with the interference part 45. Specifically, the upper corner portion of the front end of the interference part 45 enters a concave space with respect to the virtual surface VF1 (see FIG. 4) and comes into contact with the concave surface 38, and the upper surface of the interference part 45 comes into contact with the arm end portion 49. Accordingly, downward displacement of the free end 32 side is restricted. The arm part 29 is elastically deformed downward between the portion on the base end 31 side and the coupling parts 35 supported by the interference part 45, and causes the lower back portion of the reference surface 36 and the step part 37 to enter the open space 46.

As described above, while the arm end portion 49 and the concave surface 38 are in contact with the interference part 45, a portion of the arm part 29 is disposed in a thickness range of the cam part 19 (the main body part 28). The lower back portion of the reference surface 36 is located below the position of contact between the arm end portion 49, the concave surface 38, and the interference part 45. While the lock arm 13 is maximally elastically deformed in this manner, a portion of the coupling parts 35 also enters the open space 46. However, the lock arm 13 does not come into contact with the housing 11.

When the lever 12 reaches the fitting position, the lock arm 13 is displaced in the direction in which the lock arm 13 elastically returns to the natural state, and the lock projection 33 is fitted to the lock receiving part 94 from below, as shown in FIGS. 1 and 7. Accordingly, the connector 10 and the counterpart connector 90 are held in the fitted state.

As described above, according to the first embodiment, while the lock arm 13 is maximally elastically deformed, the end portion on the free end 32 side of the concave surface 38 and the like comes into contact with the interference part 45, and a portion of the reference surface 36 of the arm part 29 is located at a position lower than the upper surface of the interference part 45 interposed by the step part 37. In addition, a portion of the reference surface 36 of the arm part 29 enters the open space 46. Accordingly, the configuration of the first embodiment makes it possible to lower the height-wise position of the lock arm 13 to come into contact with the counterpart connector 90 in the course of fitting while securing the necessary amount of bending of the lock arm 13. As a result, it is possible to achieve lower profiles of the counterpart connector 90 and the connector 10.

The configuration of the first embodiment also enables effective utilization of the open space 46 that could be a dead space, at the cam part 19 of the lever 12.

Further, since the protruding part 41 is formed on the upper surface of the lock arm 13 at a position on the opposite side corresponding to the step part 37, it is possible to prevent the lock arm 13 from being partially thin at the position corresponding to the step part 37, and improve the fluidity and moldability of a resin used to mold the lock arm 13. For example, the lock arm 13 can be formed so as to extend with a constant or nearly constant vertical dimension in the front-back direction, including a portion where the protruding part 41 and the step part 37 exist.

Furthermore, in the first embodiment, each coupling part 35 is provided with the protruding part 41 and the concave surface 38, and the concave surface 38 is connected to the step part 37. Accordingly, at the time of unlocking the lock arm 13 and the lock receiving part 94, if the press part 34 is pressed and stress acts on the coupling parts 35, the stress can also be distributed to the step part 37 and the protruding part 41. Therefore, the configuration of the first embodiment makes it easy to ensure the rigidity of the coupling parts 35.

### OTHER EMBODIMENTS OF PRESENT DISCLOSURE

It should be construed that the first embodiment disclosed herein is exemplary in all respects and is not limitative.

In the first embodiment, the lock arm 13 and the main body part 28 are formed on the cam part 19 of the lever 12. Alternatively, according to another embodiment, a lock arm and a main body part may be formed in an ordinary housing.

In the first embodiment, the concave surface 38 and the protruding part 41 are formed on the coupling part 35 of the lock arm 13. Alternatively, a concave surface and a protruding part may be formed at an end portion on a free-end side of an arm part. In addition, the concave surface may be formed in the lower surface of a press part of a lock arm.

In the first embodiment, the interference part 45 is disposed at a position where contact is made with the concave surface 38 of the lock arm 13 in the course of fitting. Alternatively, an interference part may not come into contact a concave surface of a lock arm in the course of fitting and form a gap between the interference part and the concave surface. For example, the interference part may come into contact with a portion at the end portion on the free-end side of the lock arm excluding the concave surface and enter a recess between the concave surface and a step part. In addition, the interference part may come into contact with only the concave surface of the lock arm in the course of fitting and not come into contact with the arm end portion.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a lock arm that holds the connector and a counterpart connector in a fitted state; and
a main body part to which the lock arm is coupled,
wherein the lock arm extends from the main body part in the manner of a cantilever,
when the lock arm comes into contact with the counterpart connector and elastically deforms downward in a course of fitting between the connector and the counterpart connector,
the lock arm has, on a lower surface, a reference surface that is disposed so as to extend from a base end side toward a free end side and a concave surface that is located above the reference surface via a step part on the free end side in a state where the lock arm is not elastically deformed,
the main body part has an interference part that comes into contact with an end portion on the free end side including the concave surface displaced downward, and
a portion of the reference surface is set so as to be positioned below a position of contact between the end portion on the free end side and the interference part when the end portion on the free end side comes into contact with the interference part.

2. The connector according to claim 1,
further comprising a lever that advances the fitting between the connector and the counterpart connector,
wherein the main body part constitutes a main portion of a plate-like cam part of the lever, and the lock arm is constituted by a portion of the cam part excluding the main portion,
the cam part has an open space extending in a plate thickness direction, and
a portion of the reference surface enters the open space when the end portion on the free end side comes into contact with the interference part.

3. The connector according to claim 1, wherein the lock arm has a protruding part on the free end side of an upper surface.

4. The connector according to claim 3,
wherein the lock arm has an arm part that extends from the base end side toward the free end side, a press part that is disposed at the end portion on the free end side and above the arm part, and a coupling part that couples the arm part and the press part, and
the protruding part and the concave surface are provided on the coupling part.
